(19) United States
(12) Patent Application Publication
(10) Pub. No.: US 2008/0083205 A1
(43) Pub. Date: Apr. 10, 2008

(54) Method Of Bedknife Adjustment Using An Acoustical Sensor

(75) Inventor: James E. Berkeley, Pineville, NC (US)

Correspondence Address: HARNESS, DICKEY & PIERCE, P.L.C., P.O. BOX 828, BLOOMFIELD HILLS, MI, 48303, US

(73) Assignee: TEXTRON INC.

(21) Appl. No.: 11/539,923

(22) Filed: Oct. 10, 2006

(51) Int. Cl. A01D 34/53

(52) U.S. Cl. 56/249

(57) ABSTRACT

An apparatus and method for adjusting a reel-to-bedknife clearance of a lawn mower is provided. In one preferred form, a sound sensor assembly detects sound as an operator adjusts the reel-to-bedknife clearance of the mower and outputs an electrical signal corresponding to a detected sound. The detected sound is received by an evaluation module in communication with the sound sensor assembly. The evaluation module receives the electrical signal and determines whether the electrical signal indicates that a bedknife is in contact with a rotating cutting reel. Further, the evaluation module notifies an operator in response thereof.

### FIELD

The present disclosure relates to an apparatus and method for adjusting a reel-to-bedknife clearance in a lawn mower.

### BACKGROUND

The statements in this section merely provide background information related to the present disclosure and may not constitute prior art.

Various methods and mechanism exist for adjusting the clearance between a cutting reel and a bedknife in a lawn mower. In some instances, the bedknife is a moveable member, and in other instances, the cutting reel is the moveable member. For instance, in U.S. Pat. No. 3,187,492, the bedknife is movable through a threaded adjustment for establishing the position of the knife relative to the reel. Also, U.S. Pat. No. 3,106,813 shows adjustment of the bedknife relative to the reel. U.S. Pat. Nos. 3,685,265 and 4,345,419 show movement of the cutting reel relative to the bedknife. Further, U.S. Pat. No. 4,516,388 shows the application of hydraulics for moving the bedknife relative to the cutting reel to establish the clearance therebetween.

One known method of setting a desired clearance between the cutting reel and the bedknife in the field includes bring the two cutting elements into contact with each other and incrementally increasing the clearance between the two elements until an optimal clearance is reached. The optimal clearance is achieved when the two cutting elements are spaced apart enough to avoid excess wear and tear between the respective cutting edges and yet close enough that the grass will be well mowed. In determining whether a clearance is optimal, the operator repeatedly adjusts the clearance and checks each adjusted clearance by inserting a piece of material having a known thickness between the bedknife and the cutting reel until the optimal spacing is set. When the clearance is properly set, the bedknife and the cutting reel should cut the material like a sharp pair of scissors.

The present disclosure provides an apparatus and method that aid the operator to establish a reel-to-bedknife clearance for any conventional reel mower. The present disclosure differs from the prior art in that it provides an apparatus and method to aid in adjusting one of the two elements in the cutting reel and bedknife arrangement, whereby the adjustment for the reel-to-bedknife clearance is accurate and readily accomplished with little to no trial and error.

Another aspect of this disclosure includes aiding currently existing adjustment systems to achieve a minimum dimension clearance, to thus provide for the optimum adjustment and maximum efficiently by avoiding excessive wear between the respective cutting edges and to yet assure that the grass will be well mowed.

### SUMMARY

In accordance with the present disclosure, an apparatus and method for adjusting a reel-to-bedknife clearance of a lawn mower is provided. In one preferred form, a sound sensor assembly detects sound as an operator adjusts a clearance between a rotating cutting reel and a bedknife of a mower and outputs an electrical signal corresponding to a detected sound. The detected sound is received by an evaluation module coupled to the sound sensor assembly. The evaluation module receives the electrical signal to determine whether the electrical signal indicates that the bedknife is in contact with the cutting reel. Further, the evaluation module notifies the operator in response thereof.

A method of adjusting a reel-to-bedknife clearance of a mower is also provided in the present disclosure. The method includes moving a bedknife and cutting reel of the mower relative to one another to bring the bedknife and the cutting reel in contact with each other. Sound is detected and a determination is made whether the sound indicates that contact exists between the bedknife and the cutting reel in order to notify an operator in response thereof. The bedknife and the cutting reel are moved relative to one another until the sound indicates that a clearance exists between the bedknife and the cutting reel.

The present disclosure allows an operator to quickly adjust the reel-to-bedknife clearance of the mower. Additionally, the present disclosure provides an advantage of adjusting the clearance between the bedknife and the cutting reel without the use and need for various forms of material and trial and error.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an environmental view illustrating an acoustic bedknife adjustment apparatus in accordance with the present disclosure;

FIG. 2 is a block diagram of the acoustic bedknife adjustment apparatus in accordance with a preferred embodiment of the present disclosure;

FIG. 3 is a block diagram of an evaluation module in accordance with the preferred embodiment of the present disclosure;

FIG. 4 is a perspective view illustrating a sound sensor assembly in accordance with the preferred embodiment;

FIG. 5 is a cross-sectional view of the sound sensor assembly taken along line 5-5 of FIG. 4;

FIG. 6 is a side view of an attachment device of the sound sensor assembly in accordance with the preferred embodiment;

FIG. 7 is a top view illustrating the attachment device in accordance with the preferred embodiment;

FIG. 8 is a top view illustrating a housing of the sound sensor assembly in accordance with the preferred embodiment;

FIG. 9 is a cross-sectional view of the housing taken along line 9-9 of FIG. 8;

FIG. 10 is a cross-sectional view of the sound sensor assembly with a sound sensor in an alternative position in the housing;

FIG. 11 is a flow chart illustrating an operation of the acoustic bedknife adjustment apparatus in accordance with the preferred embodiment; and

FIG. 12 is a block diagram of an alternative embodiment of the evaluation module.

### DETAILED DESCRIPTION

The following description is merely exemplary in nature and is not intended to limit the present disclosure, application, or uses.

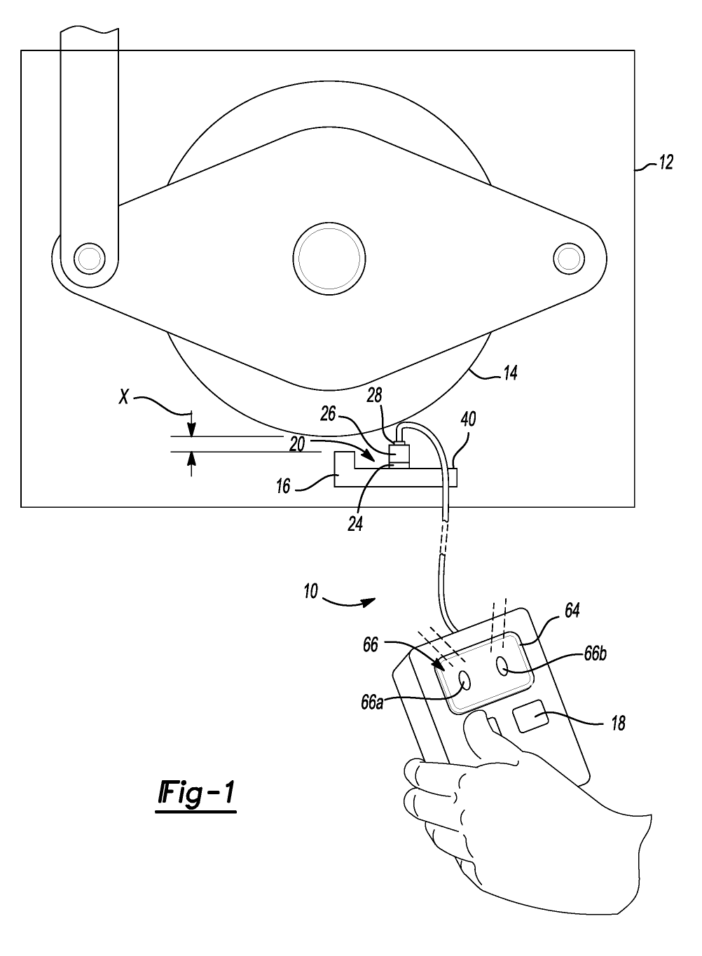

Description of the apparatus with reference to the drawings will also constitute a description of an apparatus 10 for establishing a reel-to-bedknife clearance of a lawn mower 12. Accordingly, FIG. 1 shows a lawn mower cutting reel 14 and a bedknife 16 having a clearance X therebetween. In addition, FIG. 1 shows the apparatus 10 coupled to the bedknife 16.

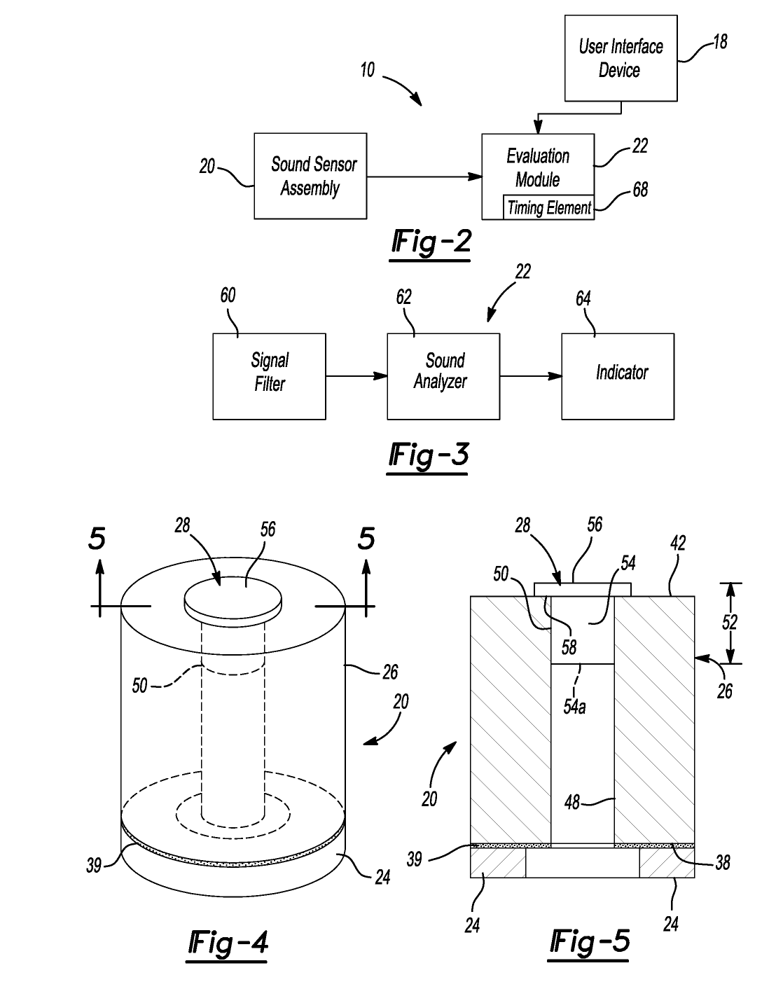

FIG. 2 illustrates the apparatus 10 as an acoustic bedknife adjustment apparatus 10. The acoustic bedknife adjustment apparatus 10 includes a user interface device 18, a sound sensor assembly 20, and an evaluation module 22. The user interface device 18 is in communication with the evaluation module 22. Likewise, the sound sensor assembly 20 is in communication with the evaluation module 22.

Referring to FIGS. 1 and 2, the user interface device 18 allows a user to activate and deactivate the acoustic bedknife adjustment apparatus 10. When initiated by the user, the user interface device 18 outputs an activation signal to the evaluation module 22 such that the evaluation module 22 is turned ON to communicate with the sound sensor assembly 20. Likewise, when initiated by the user, the user interface device 18 outputs a deactivation signal to the evaluation module 22 such that the evaluation module 22 stops communicating with the sound sensor assembly 20.

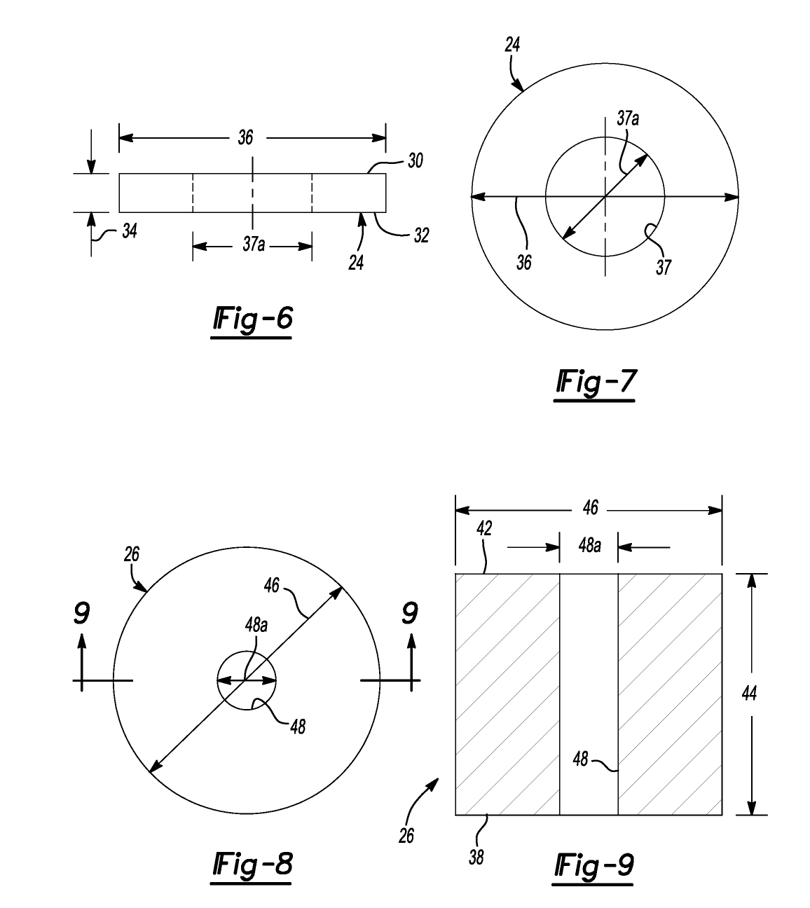

Referring to FIGS. 1 and 4-10, the sound sensor assembly 20 comprises an attachment device 24, a housing 26 and a sound sensor 28. The attachment device 24 is coupled to the housing 26. The housing 26 is, in turn, coupled to the sound sensor 28. As shown in FIG. 1, the attachment device 24 couples the sound sensor assembly 20 to the bedknife 16. The attachment device 24 comprises a magnetic material such as ferrite formed in a geometric shape. For example, the geometric shape may comprise a cylinder shape having a first end face 30 and a second end face 32, a length 34 and a diameter 36 as shown in the Figures. In the embodiment depicted in FIGS. 6 and 7, the length 34 includes a range of ⅛″ to 3/16″. The attachment device 24 also includes an aperture 37 having a diameter 37a that extends the length 34 of the attachment device 24. As shown in FIGS. 4 and 5, the first end face 30 is fixed to a bottom surface 38 of the housing 26. A suitable adhesive 39 or some other attachment mechanism such as mechanical fasteners may be used to couple the housing 26 and the attachment device 24. The second end face 32 engages a mounting face 40 of the bedknife 16 (see FIG. 1). Because the bedknife 16 is constructed from a ferro or ferri magnetic material, the attachment device 24 adheres thereto.

FIGS. 8 and 9 depict the housing 26 as being constructed from a metal material, such as steel; however, the housing 26 may be constructed from a polymeric material such as a phenol material. The housing 26 includes a geometric shape such as a cylinder shape having the bottom surface 38, an upper surface 42, a length 44 and a diameter 46. The shape of the housing 26 has the same shape as the attachment device 24. One skilled in the art will appreciate that the shape of the housing 26 and the shape of the attachment device 24 may have a different geometric shape. The housing 26 includes a through bore 48 extending the length 44. The bore 48 is cylindrically shaped having a diameter 48a.

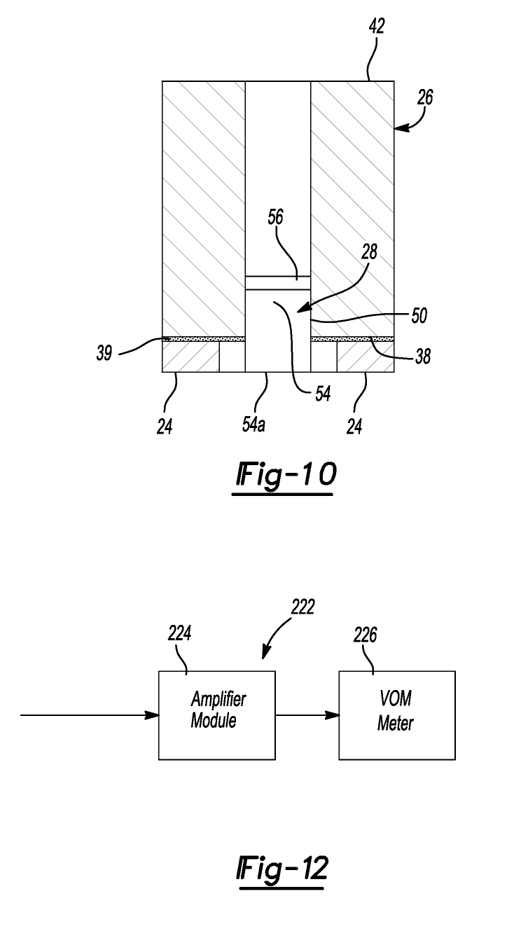

As shown in FIGS. 4 and 5, the sound sensor 28 comprises a microphone assembly. The sound sensor 28 detects sound in real-time as an operator adjusts a reel-to-bedknife clearance of the mower 12. The sound sensor 28 includes a substantially cylindrically shaped body portion 50 having a length 52 approximately at least a portion of the length 44 of the housing 26 and includes an outer diameter substantially the same as the diameter 48a of the bore 48 of the housing 26. The sound sensor 28 also includes a head portion 54 positioned within the bore 48 and an end portion 56 having a surface 58 engaging with the upper surface 42 of the housing 26. Referring to FIG. 10, alternatively, a surface 54a of the head portion 54 may be aligned with the second end face 32 of the attachment device 24 and substantially mounted to the mounting face 40 of the bedknife 16; and, the end portion 56 of the sound sensor 28 is configured to reside with the bore 48. In detecting sound, the sound sensor 28 outputs an electrical signal that corresponds to a detected sound.

Again referring to FIG. 2, the evaluation module 22 receives the activation signal from the user interface device 18. Once the activation signal is received, the evaluation module 22 activates and begins receiving the electrical signal from the sound sensor assembly 20. Otherwise, if the evaluation module 22 receives the deactivation signal from the user interface device 18, the evaluation module 22 deactivates or remains deactivated. As shown in FIG. 3, the evaluation module 22 comprises a signal filter 60, a sound analyzer 62, and an indicator 64. The sound sensor assembly 20 is coupled to the signal filter 60. The signal filter 60 is, in turn, coupled to the sound analyzer 62. The sound analyzer 62 is, in turn, coupled to the indicator 64.

The signal filter 60 attenuates frequencies above and/or below a selected center frequency related to the electrical signal. In other words, the signal filter 60 eliminates high and/or low frequency interference noise from the electrical signal and produces a filtered electrical signal. The signal filter 60 receives the electrical signal from the sound sensor 28. The signal frequency filter comprises a high pass filter (HPF) and a low pass filter (LPF). The HPF allows high frequencies to pass and filters out the low frequencies. The HPF filters out changes in the electrical signal that occur over a specific period of time. On the other hand, the LPF allows low frequencies to pass and filters out the high frequencies such that all portions of the signal that change rapidly are filtered. Alternatively, the signal filter 60 may include of a band pass filter (BPF) which is a combination of high and low pass filter.

The sound analyzer 62 receives a filtered electrical signal and determines whether the filtered electrical signal indicates that contact exists between the bedknife 16 and the cutting reel 14. The sound analyzer 62 comprises a noise analyzer such that the noise analyzer compares the filtered electrical signal to a profile signal to determine whether the filtered electrical signal indicates that contact exists between the bedknife 16 and the cutting reel 14. The profile signal is a prerecorded electrical signal having characteristics that indicate contact between the bedknife 16 and the cutting reel 14. After determining whether the filtered signal indicates that contact exists between the bedknife 16 and the cutting reel 14, the noise analyzer outputs a contact signal in response thereof.

The indicator 64 receives the contact signal and notifies the operator when contact exists between the bedknife 16 and the cutting reel 14. Referring to FIG. 1, the indicator 64 may comprise a visual display 66 such as at least one light source 66a that illuminates when the contact signal indicates that contact exists between the bedknife 16 and the cutting reel 14. The light source 66a includes at least one LED light source. Alternatively, the visual display 66 may include a digital indicator.

Another aspect of the embodiment includes the acoustic bedknife adjustment apparatus 10 determining when the clearance X between the bedknife 16 and the cutting reel 14 is less than a predetermined minimum contact threshold. Stated another way, the minimum contact threshold is indicative of a contact between the bedknife 16 and the cutting reel 14 that may cause excess wear and tear on the bedknife 16, the cutting reel 14 or both. For example, as a detected sound indicates that contact exists between the bedknife 16 and the cutting reel, the sound sensor 28 outputs a corresponding electrical signal. Likewise, as the sound increases in volume, the corresponding electrical signal is increased. More specifically, after receiving the filtered electrical signal, the sound analyzer 62 compares the filtered electrical signal to the minimum contact threshold. If the filtered electrical signal is about or exceeds the minimum contact threshold, the sound analyzer 62 outputs a threshold-exceeding signal to the indicator 64.

Additionally, the indicator 64 receives the threshold-exceeding signal and notifies the operator via the visual display 66 in response thereof. For example, the visual display 66 may comprise at least one light source 66b that illuminates (see FIG. 1) when the indicator 64 receives the threshold-exceeding signal. Otherwise, the light source 66b is turned OFF.

A further aspect of the acoustic bedknife adjustment apparatus 10 provides an automatic shut-off feature. The automatic shut-off feature shuts OFF or deactivates the acoustic bedknife adjustment apparatus 10 when non-contact exists between the bedknife 16 and the cutting reel 14 after a predetermined period of time. As shown in FIG. 2, the evaluation module 22 comprises a timing element 68. The timing element 68 is activated when the activation signal is received by the evaluation module 22. If the evaluation module 22 does not receive the electrical signal prior to the predetermined period of time expiring, the timing element 68 outputs a timing deactivation signal to turn OFF the evaluation module 22. On the other hand, if the evaluation module 22 receives the electrical signal from the sound sensor assembly 20 during or before the predetermined period of time expires, the evaluation module 22 resets the timing element 68.

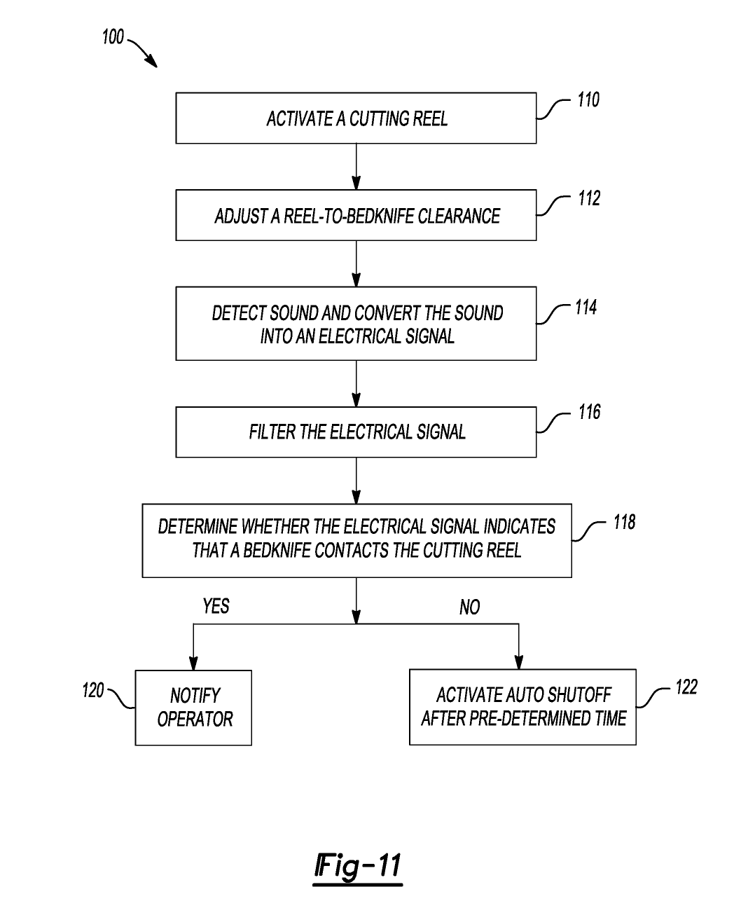

As illustrated in FIG. 11, an operation 100 for employing the acoustic bedknife adjustment apparatus 10 is provided. With the sound sensor assembly 20 mounted onto the bedknife 16 and the evaluation module 22 activated, the operator actuates the cutting reel 14 to rotate as in a grass cutting operation at operation 110. With the cutting reel 14 rotating, the operator adjusts the clearance X between the cutting reel 14 and the bedknife 16 at operation 112. This is done using conventional means either by moving the bedknife 16 in relation to the cutting reel 14 or the cutting reel 14 in relation to the bedknife 16 to adjust the clearance X.

As the clearance X is adjusted, the sound sensor assembly 20 detects sound at operation 114. The sound is converted into an electrical signal and outputted to the signal filter 60. At operation 116, the signal filter 60 filters the electrical signal by attenuating frequencies above and/or below a selected center frequency. It also outputs a filtered electrical signal. The filtered electrical signal is then analyzed to determine whether contact exists between the bedknife 16 and the cutting reel 14 by the sound analyzer 62 at operation 118.

The sound analyzer 62 compares the filtered electrical signal to a profile signal to determine whether the bedknife 16 is in contact with the cutting reel 14. If the electrical signal indicates that contact exists between the bedknife 16 and the cutting reel 14, the sound analyzer 62 outputs a contact signal indicating that contact exists. At operation 120, the indicator 64 receives the contact signal and notifies the operator. More specifically, when contacts exists, the light source 66a illuminates. The operator readjusts the clearance X until the light source 66a darkens. This allows the indicator 64 to notify the operator that contact between the bedknife 16 and the cutting reel 14 no longer exists. Additionally, when the light source 66 darkens, the clearance X is set to a minimal optimal distance. If the evaluation module determines that contact does not exist between the cutting reel 14 and the bedknife 16 after a predetermined period of time, the automatic shutoff feature is activated to turn OFF the acoustic bedknife adjustment apparatus 10 at operation 122.

Referring to FIG. 12, an alternative embodiment of the evaluation module 22 is provided as an evaluation module 222. Like components have been identified with like reference numbers. The evaluation module 222 comprises an amplifier module 224 and a Voltage, Ohms, or Milliamperes (VOM) meter 226. The sound sensor assembly 20 communicates with the amplifier module 224. The amplifier module 224 in turn communicates with the VOM meter 226.

The amplifier module 224 receives the electrical signal. The electrical signal is amplified, by a predetermined factor, such that the electrical signal is within a signal range capable of being measured by the VOM meter 226. The VOM meter 226, in turn, receives and measures an amplified electrical signal. Once the electrical signal is measured, the VOM meter 226 displays a measured reading of the amplified electrical signal indicating whether contact exists between the bedknife 16 and the cutting reel 14. The VOM meter 226 may comprise a digital or analog VOM meter. For example, the VOM meter 226 may comprise a Triplett 630 PI VOM meter by the Triplett Corporation in Bluffton, Ohio.

The present disclosure allows an operator to adjust quickly the reel-to-bedknife clearance of the mower. Additionally, the present disclosure provides an advantage of adjusting a clearance between the bedknife 16 and the cutting reel without the use and need for various forms of material and trial and error.

Additionally, various aspects of the present invention have been disclosed, it should be appreciated that variations may be made without departing from the scope of the present invention. For example, the acoustic adjustment bedknife apparatus 10 is depicted in FIG. 1 as a hand-held unit, the acoustic adjustment bedknife apparatus 10 may be integrated into a lawn mower control system. Additionally, instead of using the user interface device 18, the acoustic adjustment bedknife apparatus 10 may alternatively activate and deactivate the evaluation module based on system parameters (e.g. ignition start up, mileage, hours of operation, etc.) of a particular lawn mower such that the method described herein is automated. Furthermore, various materials have been disclosed in an exemplary fashion, but other materials may of course be employed, although some of the advantages of the present invention may not be realized. It is intended by the following claims to cover these and any other departures from the disclosed embodiments, which fall within the true spirit of the invention.

What is claimed is:

1. A method of adjusting a reel-to-bedknife clearance of a mower comprising:
moving a bedknife and a cutting reel of the mower relative to one another to bring the bedknife and the cutting reel in contact with each other;
detecting sound;
determining whether the sound indicates that contact exists between the bedknife and the cutting reel in order to notify an operator in response thereof; and
moving the bedknife and the cutting reel relative to one another until the sound indicates that a clearance exists between the bedknife and the cutting reel.

2. The method of claim 1 further including continuing to move the bedknife and the cutting reel away from each other for a predetermined time after determining that contact between the bedknife and the cutting reel no longer exists to set a desired clearance.

3. The method of claim 1 further including converting the sound into an electrical signal.

4. The method of claim 1 further including activating the cutting reel such that the cutting reel rotates prior to detecting the sound.

5. The method of claim 3 further including filtering the electrical signal to attenuate frequencies above a selected center frequency.

6. The method of claim 3 further including comparing the electrical signal to a profile signal having contact characteristics to determine whether the bedknife is in contact with the cutting reel.

7. The method of claim 1 further including activating an automatic shut-off feature when the sound indicates that contact is non-existent between the bedknife and the cutting reel after a predetermined period of time.

8. The method of claim 1 further including using a visual display to indicate that contact exists between the bedknife and the cutting reel.

9. An acoustic bedknife adjustment apparatus comprising:
a sound sensor assembly adapted to detect sound as an operator adjusts a clearance between a rotating cutting reel and a bedknife of a mower, the sound sensor assembly being operable to output an electrical signal corresponding to a detected sound; and
an evaluation module in communication with the sound sensor assembly and configured to receive the electrical signal to determine whether the electrical signal indicates that the bedknife is in contact with the cutting reel, wherein the evaluation module notifies an operator in response thereof.

10. The acoustic bedknife adjustment apparatus of claim 9, wherein the evaluation module comprises a voltage, ohms, and milliamperes (VOM) meter configured to receive and measure the electrical signal such that the VOM meter displays a measured reading of the electrical signal indicating whether contact exists between the bedknife and the cutting reel.

11. The acoustic bedknife adjustment apparatus of claim 9, wherein the evaluation module is further configured to compare the electrical signal to a profile signal to determine whether the electrical signal indicates that contact exists between the bedknife and the cutting reel.

12. The acoustic bedknife adjustment apparatus of claim 11, wherein the profile signal includes a prerecorded electrical signal indicating existence of contact between a bedknife and a cutting reel.

13. The acoustic bedknife adjustment apparatus of claim 9 further including an automatic shut off feature configured to turn off the acoustic bedknife adjustment apparatus when non-contact exists between the bedknife and the cutting reel after a predetermined period of time.

14. The acoustic bedknife adjustment apparatus of claim 9, wherein the sound sensor assembly includes an attachment device configured to couple the sound sensor assembly to the bedknife of the mower.

15. The acoustic bedknife adjustment apparatus of claim 9, wherein the evaluation module includes an indicator configured to display whether contact exists between the bedknife and the cutting reel.

16. An apparatus comprising:
a sound sensor operable to detect sound as an operator adjusts a clearance between a rotating cutting reel and a bedknife of a mower and output an electrical signal corresponding to the sound;
a sound analyzer in communication with the sound sensor and configured to determine when the electrical signal indicates contact between the bedknife and the cutting reel, wherein the sound analyzer outputs a contact signal in response thereof; and
an indicator in communication with the sound analyzer and configured to receive the contact signal to notify the operator whether contact exists between the bedknife and the rotating cutting reel.

17. The apparatus of claim 16, wherein the sound analyzer is further configured to compare the electrical signal to a profile signal having characteristics indicating that contact exists between the bedknife and the rotating cutting reel in order to determine whether contact exists.

18. The apparatus of claim 16, wherein the indicator includes at least one light source configured to illuminate when the contact signal is indicative of contact existing between the bedknife and the rotating cutting reel.

19. The apparatus of claim 16, wherein the indicator includes at least one light source configured to illuminate when the contact signal indicates that an amount of contact between the bedknife and the rotating cutting reel exceeds a contact threshold.

20. The apparatus of claim 16 further including a filter in communication with the sound sensor and the sound analyzer and configured to attenuate frequencies below or above a selected center frequency related to the electrical signal outputted by the sound sensor.

21. The apparatus of claim 16, wherein the sound sensor includes a microphone assembly.
